(19) United States
(12) Patent Application Publication
(10) Pub. No.: US 2004/0052376 A1
(43) Pub. Date: Mar. 18, 2004

(54) Secure modem transmission

(76) Inventors: Abraham Fisher, Haifa (IL); Oren Somekh, D.N. Emek-Israel (IL)

Correspondence Address: William H Dippert, Reed Smith, 29th Floor, 599 Lexington Avenue, New York, NY, 10022-7650, US

(21) Appl. No.: 10/451,082

(22) PCT Filed: Dec. 19, 2000
(86) PCT No.: PCT/IL00/00848

(51) Int. Cl. G06F 11/30

(52) U.S. Cl. 380/257; 713/201

(57) ABSTRACT

A method of access control to a protected remote access server. The method includes receiving signals transmitted on a modem connection, determining in the physical layer whether the received signals include predetermined identification signals, and allowing the modem connection to be established with the protected remote access server only if the received signals include the predetermined identification signals.

### FIELD OF THE INVENTION

The present invention relates to communication systems and in particular to data connections over voice networks.

### BACKGROUND OF THE INVENTION

Communication networks allow remote usage of computers and access to information stored on remote computers. Computers which are meant for remote access, referred to as servers, are connected to data networks and/or remote access servers (RAS) which allow users of remote computers, referred to as clients, to communicate with the servers. Opening servers for remote access simplifies the access also to illegal connections directed to view secret information and/or to sabotage the server.

In order to prevent illegal access various protective means are used, including passwords, firewalls and encoding schemes. The producers of the protective means are in continuous rivalry with computer hackers who search for methods to work around the protective means.

Amendment 1 of the T.30 ITU recommendation 7/97, the disclosure of which is incorporated herein by reference, describes standard encryption methods to be used in fax transmission. In these methods the establishment of a connection includes a preliminary stage in which encryption keys are exchanged. Thereafter, the fax data is transmitted in its entirety in an encrypted form.

### SUMMARY OF THE INVENTION

An aspect of some embodiments of the present invention relates to performing access control to a server at the physical level of a communication protocol. Performing the access control in the physical level means that security checks are performed based on the signals transmitted on a communication link, being accessed using methods and/or apparatus other than used in converting the data signals transmitted on the communication link to bits.

In some embodiments of the invention, in order to form a connection with a modem, or array of modems (referred to as a remote access server (RAS)), associated with the accessed server, the user must transmit toward the server, security signals which are not in accordance with the protocol used in transmitting data and/or forming a connection with the RAS. Thus, special hardware is required in order to access the server and hackers using standard apparatus cannot access the server regardless of their knowledge in communication protocols. The security signals may be variations of data signals which are used also to convey data or signals used only for security purposes.

In some embodiments of the invention, the security signals transmitted on a connection do not prevent standard RAS apparatus from decoding the data signals on the connection. Thus, appartus for generating the security signals may be used also when connecting to a modem or RAS which does not perform access control. For example, a single secure modem may be used by a worker to securely contact a RAS of a workplace of the worker and contact a non-secured Internet service provider (ISP).

An aspect of some embodiments of the present invention relates to performing access control by apparatus which cannot be programmed remotely over the communication connection. In some embodiments of the invention, the access control is performed by apparatus separate from the server being protected. Optionally, the access control is performed by apparatus which has limited programming abilities and not by a general purpose computer. Alternatively or additionally, the access control is performed by a remote access server (RAS) handling the user connections.

An aspect of some embodiments of the present invention relates to performing access control of a modem connection while the connection is being established, such that illegal connections may be disconnected before data signals are passed on the connection. Optionally, illegal connections are disconnected before modem information is exchanged during the connection establishment. Thus, remote users not authorized to connect to a modem cannot even receive information on the attributes of the modem.

In some embodiments of the invention, authorized remote users are provided with security plugs to be connected between the user's modem (referred to as a call modem) and a communication network through which the call modem connects to a RAS which is used to connect to the server. Alternatively, authorized users are provided with a proprietary call modem which includes within it an internal security plug.

In some embodiments of the invention, the security plug comprises a passive element, such as a filter which alters the transmitted signals at one or more specific frequencies according to a specific identification code. The specific identification code may comprise a general access code and/or a user specific signature. The alterations applied by the filter are chosen such that they are not superseded by noise effects and do not substantially affect the decoding of the transmitted signals. In some embodiments of the invention, the alterations applied by the filter are chosen such that they are not canceled by noise cancellation procedures performed before the access control verification. In some embodiments of the invention, the filter removes from the transmitted signals specific frequencies. Alternatively or additionally, the filter reduces the amplitude of the signals at specific frequencies.

In some embodiments of the invention, the security plug comprises an active device which generates identification signals which are superimposed onto the signals transmitted from the call modem to the RAS. Optionally, the security plug listens to the signals transmitted by the call modem on the connection between the call modem and the RAS and, responsive to specific signals generated by the call modem, the security plug transmits one or more predetermined respective identification signals. The identification signals are transmitted immediately after the predetermined signal from the call modem is identified or a predetermined time thereafter.

Alternatively or additionally, one or more identification signals are transmitted responsive to signals transmitted from the RAS to the call modem. Optionally, the identification signals are transmitted responsive to signals generated by the RAS, in accordance with a protocol of signal transmission between the call modem and the RAS.

In some embodiments of the invention, a RAS keeper, which checks for the existence of the identification signals in the signals transmitted from the call modem, transmits commands to the security plug. Such commands may include, for example, a command to change the identification code, to send one of a plurality of identification codes or to generate an identification code based on a key supplied by the RAS keeper.

In some embodiments of the invention, the security plug generates signals during recesses in the transmission of signals by the modem, e.g., between phases of the negotiation stage of the connection, and/or during periods in which the entire available spectrum is not used by the modem. In some embodiments of the invention, the identification signals comprise signals which are ignored by the RAS. In an exemplary embodiment of the invention, the identification signals are transmitted with an amplitude substantially lower than the primary signals on the connection. Alternatively or additionally, the identification signals are removed from the connection, for example by introduction of counter phased signals, before they reach the RAS.

In an exemplary embodiment of the invention, the identification signals are transmitted during the transmission of the CNG and/or the CED signals defined by the T.30 ITU recommendation and/or during the transmission of the CM and/or ANSam signals defined by the V.34 ITU recommendation.

In some embodiments of the invention, the security plug is operative throughout the duration of the connection. Alternatively, the security plug is operative only during the negotiation stage of the connection.

There is therefore provided in accordance with an embodiment of the present invention, a method of access control to a protected remote access server, comprising receiving signals transmitted on a modem connection, determining in the physical layer whether the received signals include predetermined identification signals, and allowing the modem connection to be established with the protected remote access server only if the received signals include the predetermined identification signals. Optionally, determining whether the received signals include predetermined identification signals comprises determining by apparatus separate from the protected remote access server. In some embodiments of the invention, determining whether the received signals include predetermined identification signals comprises determining by apparatus which cannot be programmed remotely over the modem connection.

Possibly, determining whether the received signals include predetermined identification signals comprises determining before data signals are transmitted on the modem connection and/or before decoding data signals transmitted on the modem connection. Optionally, determining whether the received signals include predetermined identification signals comprises determining without decoding data signals transmitted on the modem connection.

In some embodiments of the invention, determining whether the received signals include predetermined identification signals comprises determining after receiving specific signals of a negotiation stage of the modem connection. Optionally, determining whether the received signals include predetermined identification signals comprises determining at one or more predetermined times during the connection.

Optionally, determining whether the received signals include predetermined identification signals comprises determining whether the frequency spectrum of the received signals have one or more predetermined characteristics. Alternatively or additionally, determining whether the received signals include predetermined identification signals comprises determining whether the received signals include one or more predetermined modulated codes. Optionally, the modulated codes are modulated using a modulation method different from that used in modulating data signals passed on the connection.

In some embodiments of the invention, determining whether the received signals include predetermined identification signals comprises determining whether the received signals include one or more predetermined frequency signals. Optionally, the method includes transmitting one or more signals on a down-link channel of the modem connection and wherein determining whether the received signals include predetermined identification signals comprises determining whether the received signals include signals generated responsive to the one or more down-link signals.

There is further provided in accordance with an embodiment of the present invention, a method of providing identification signals for user authentication in a modem connection, comprising connecting a security plug between a modem and a remote access server, transmitting signals between the modem and the remote access server, and altering, during a connection establishment session, the transmitted signals, by the security plug.

Optionally, altering the signals comprises passing the signals through at least one filter which alters the amplitude of a narrow frequency band of the signals optionally, connecting the security plug comprises connecting a passive element. Alternatively or additionally, altering the signals comprises superimposing at least one identification signal on the signals transmitted from the modem. Optionally, superimposing the at least one identification signal to the signals transmitted from the modem comprises identifying a predetermined signal transmitted to or from the modem and superimposing a respective identification signal responsive to the identification. Optionally, superimposing the at least one identification signal comprises superimposing at a predetermined time after the identification of the predetermined signal. Optionally, connecting the security plug comprises connecting a security plug which does not change data signals transmitted between the modem and the remote access server in a manner which requires a change in their decoding. Alternatively or additionally, connecting the security plug comprises connecting a security plug which does not change data signals transmitted between the modem and the remote access server.

There is further provided in accordance with an embodiment of the present invention, a security plug, comprising an input interface which receives signals directed from a modem to a remote access server and an identification imprinting element which alters at least some of the signals received by the input interface so that the signals will pass a security check, but does not alter data signals in a manner which requires different decoding procedures than non-altered data signals. Optionally, the identification imprinting element comprises at least one narrow band filter. Optionally, the identification imprinting element alters signals only during a connection establishment period. Possibly, the identification imprinting element is powered from a line on which the signals from the modem to the remote access server are transmitted. Alternatively, the identification imprinting element does not require a power source. In some embodiments of the invention, the security plug includes a battery which powers the identification imprinting element.

There is further provided in accordance with an embodiment of the present invention, an access control unit, comprising an input interface adapted to receive signals directed from a modem to a remote access server, a verification unit adapted to examine the signals received by the input interface in the physical layer to determine whether the received signals include predetermined identification signals, and a gating unit which disconnects connections for which the received signals do not include the predetermined identification signals.

Optionally, the access control unit includes an output interface which provides the received signals from the input interface substantially intact. Optionally, the access control unit includes a modification unit which removes at least some of the predetermined identification signals identified by the verification unit.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a remote access connection, in accordance with an embodiment of the present invention;

FIG. 2 is a graph of the frequency spectrum of signals which passed through a security plug, in accordance with an embodiment of the present invention; and

FIG. 3 is a schematic block diagram of an active security plug, in accordance with an embodiment of the present invention.

### DETAILED DESCRIPTION OF EMBODIMENTS

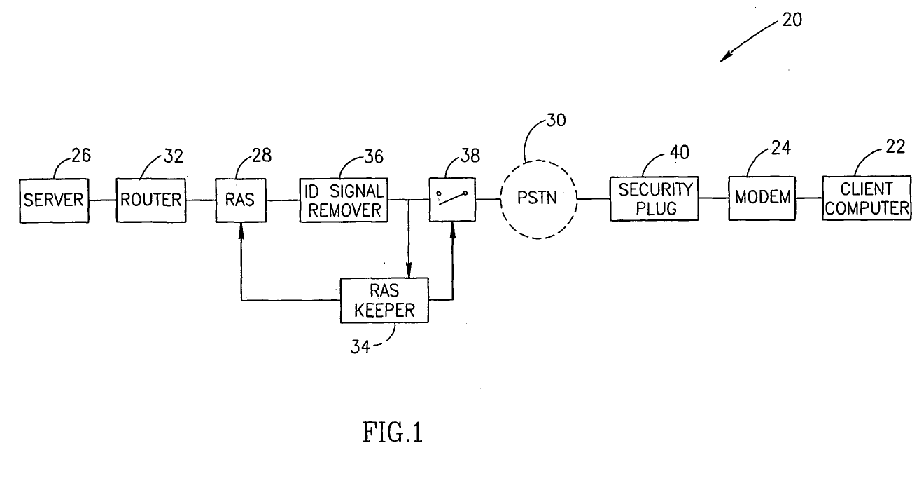

FIG. 1 is a schematic illustration of a remote access connection 20, in accordance with an embodiment of the present invention. A client computer 22 connects over a network, for example a public switched telephone network (PSTN) 30 to a server 26. Client computer 22 connects to PSTN 30 through a modem 24 and a security plug 40 described hereinbelow. Server 26 generally connects to PSTN 30 through a remote access server (RAS) 28 and a router 32. In some embodiments of the invention, a RAS keeper 34 listens to the signals transmitted to RAS 28 from PSTN 30 to verify that the signals include predetermined coded characteristics implanted by security plug 40. If the coded characteristics are not identified in accordance with a predefined protocol, e.g., within a predetermined time, RAS keeper 34 disconnects the connection with client computer 22. Alternatively, RAS keeper 34 redirects the signals from client computer 22 to a security monitor (not shown) which uses the signals to determine the identity of the client computer 22 illegally attempting to connect to server 26. Optionally, RAS keeper 34 disconnects and/or redirects illegal connections by instructing a switch box 38 through which the connections with server 26 pass and/or by instructing RAS 28.

In some embodiments of the invention, a signal remover 36 cancels the effect of security plug 40, such that RAS 28 receives the signals substantially as they were generated by modem 24, without the effect of security plug 40. Alternatively, signal remover 36 is not used and the effect of security plug 40 on the transmitted signals is chosen such that it does not prevent RAS. 28 from interpreting the signals and does not require a reduction in the transmission rate of signals on connection 20. Alternatively, the use of security plug 40 reduces the transmission rate of data signals on connection 20.

In some embodiments of the invention, security plug 40 comprises one or more passive filters which reduce the amplitude of the transmitted signals at specific frequencies. Alternatively or additionally, security plug 40 boosts the amplitude of the signals at one or more specific frequencies. RAS keeper 34 analyzes the frequencies of the signals received from client computer 22 (for example using an FFT analyzer) and allows a connection to be established only if the effect of security plug 40 in the specific frequencies is evident in the received signals. In some embodiments of the invention,. RAS keeper 34 examines the received signals at specific stages of the connection in order to determine the frequency spectrum of the received signals and accordingly verify that security plug 40 was used. In some embodiments of the invention, RAS keeper 34 examines the received signals during a negotiation stage of the connection when the contents of the signals are known, i.e., they adhere to a predefined standard. Alternatively or additionally, RAS keeper 34 examines the received signals during data transmission. Optionally, RAS keeper 34 receives feedback on the received signals from RAS 28 and accordingly determines whether the received signals passed through security plug 40. For example, RAS keeper 34 may receive from RAS 28 the decoded signals and regenerate therefrom the signals which would have been transmitted if security plug 40 was not used. In some embodiments of the invention, by comparing the frequency spectrum of the regenerated signals to the frequency spectrum of the signals actually transmitted, RAS keeper 34 determines whether the received signals passed through security plug 40.

Optionally, RAS keeper 34 examines each connection at a predetermined number of predefined stages of the connection and only if at all the predefined stages the effect of security plug 40 (e.g., the frequency stamp) is evident, the connection is allowed to proceed. Altematively, the effect of security plug 40 must be found in a predetermined percent of the verification points. Thus, even if due to sporadic noise the frequency stamp of security plug 40 is not found in one of the examination stages the connection is allowed if, during a predetermined percent of the examination stages, the frequency stamp is found by RAS keeper 34. Further alternatively, RAS keeper 34 examines the received signals for a predetermined period until the existence of the frequency stamp of security plug 40 is determined or the predetermined period is over.

In some embodiments of the invention, security plug 40 does not prevent the signals from modem 24 from being detected even if RAS keeper 34 is not operative or is not existent. Thus, modem 24, with security plug 40, may be used to contact any modem, even one which does not have a compatible RAS keeper 34. Optionally, for example when server 26 carries very confidential information, RAS 28 is deactivated when RAS keeper 34 is not operative.

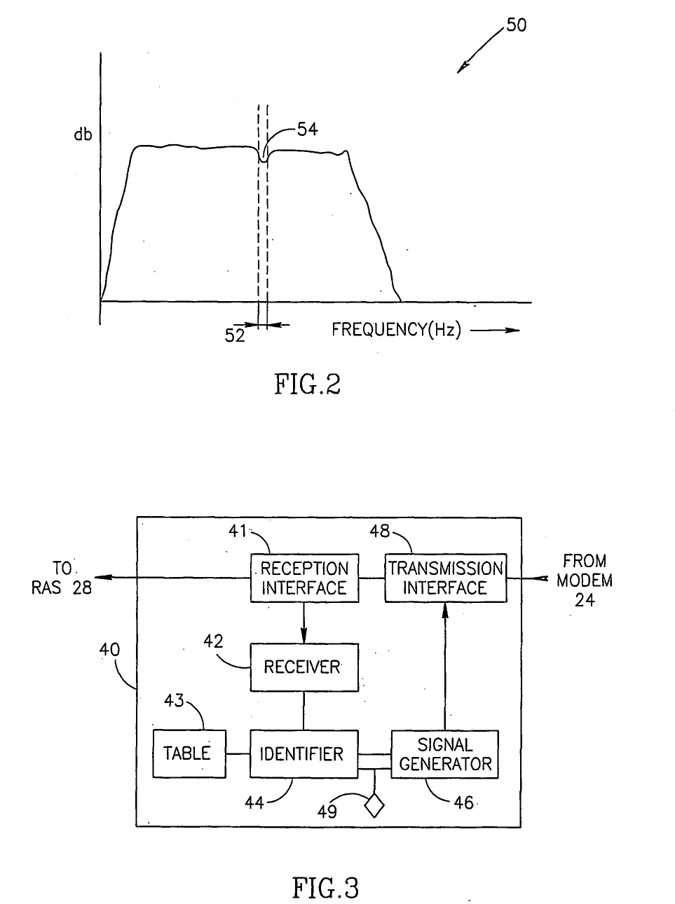

FIG. 2 is a graph 50 of the frequency spectrum of signals passing through security plug 40, in accordance with an embodiment of the present invention. Security plug 40 reduces the amplitude of the signal components having a frequency within a narrow band 52, forming a notch 54. The.width and/or amplitude of notch 54 are optionally chosen so as to have a size which is not obstructed by average noise levels on the one hand, and does not interfere with the decoding of signals by RAS 28, on the other hand. In an exemplary embodiment of the invention, notch 54 has a width of between about 10-200 Hz (optionally depending on the frequency band of the notch) and an amplitude reduction of between about 5-15%. Alternatively, the amplitude reduction is even higher for example up to about 50%. Further alternatively, plug 40 entirely removes a narrow frequency band.

In some embodiments of the invention, the frequency band affected by plug 40 carries at least some of the energy during at least some of the transmission periods of modem 24, particularly during periods in which security verification is performed by RAS keeper 34. Optionally, however, the frequency band affected by plug 40 does not carry a substantial portion of the energy of the transmitted signals so as not to disrupt the decoding of the transmitted signals.

In some embodiments of the invention, security plug 40 comprises a plurality of filters which imprint a plurality of frequency notches. The amplitude and frequency bands of the notches may be used to distinctly identify security plug 40. Optionally, RAS keeper 34 carries a list of valid security plugs from which connections are allowed. Thus, if a security plug 40 is stolen the entry of the security plug 40 may be removed from the list of valid security plugs.

In some of the embodiments of the invention in which signal remover 36 is used, signal remover 36 comprises a filter which increases the amplitude of the signals in the frequency band of notch 54, so as to substantially eliminate the notch. Alternatively or additionally, notch 54 is relatively small, such that RAS 28 automatically compensates for the notch in a manner similar to the correction of disturbances due to the physical link (e.g., twisted pair) on which the connection is passed.

In some embodiments of the invention, security plug 40 comprises a plurality of states which have different effects on the signals from client computer 22 passing through it. For example, security plug 40 may have a distortion state in which the signals are changed, e.g., in accordance with any of the above described methods, and a neutral state in which the signals remain intact. During a negotiation stage at the beginning of the connection the distortion state is used and afterwards, when the identity of the user of client computer 22 has been verified, the neutral state is used, in order not to interfere with the interpretation of the transmitted signals. Optionally, security plug 40 automatically moves to the neutral state after a predetermined time or after the transmission of a specific predetermined signal (e.g., after the end of the negotiation).

In some embodiments of the invention, security plug 40 comprises a timer which sets the time for which the distortion state is used. Optionally, the time for which the distortion state is in effect is used in determining whether to allow the connection. If the distortion state is used for a substantially longer and/or shorter period than a predefined period, the connection is disconnected.

Alternatively or additionally, security plug 40 requires entrance of a code and/or insertion of a key in order to operate in the distortion mode. Thus, even if security plug 40 is stolen it cannot be used without the code or key.

Further alternatively or additionally, security plug 40 comprises a plurality of distortion states from which the user may choose an appropriate state or sequence of states. The distortion states may differ, for example, in the frequency band which they affect and/or in the magnitude of their amplitude decrease (or increase). In some embodiments of the invention, different states may be used for calling different servers. Alternatively or additionally, different states are used at different times of day and/or at different dates, as an additional security measure. In some embodiments of the invention, the user may adjust the amplitude decrease or increase, so as to achieve an optimal tradeoff between passing the security check of RAS keeper 34, and achieving a good transmission quality.

FIG. 3 is a schematic illustration of security plug 40, in accordance with an embodiment of the present invention. In the embodiment of FIG. 3, security plug 40 comprises an active element, such as a signal generator 46, which generates identification signals which are added to the signals transmitted from client computer 22 to server 26. Optionally, a table 43 lists one or more identification signals which are to be transmitted and the times at which they are to be transmitted. In some embodiments of the invention, security plug 40 comprises a reception interface 41 which listens to the signals transmitted on an up-link (from modem 24 to RAS 28) channel from computer 22 to server 26, and passes the signals to a receiver 42. Optionally, receiver 42 comprises a standard modem front end, as is known in the art, which interprets the signals it receives. An identifier 44 searches the signals on the up-link channel for one or more predetermined signal sequences, which are used in the timing of the transmission of the identification signals in table 43. Signal generator 46 generates the identification signals which are transmitted on the up-link channel, for example, using a transmission interface 48. RAS keeper 34 (FIG. 1) comprises a table with identical signals as table 43, which table is used in verifying that proper identification signals were transmitted.

In some embodiments of the invention, identifier 44 and/or signal generator 46 are implemented by a low power processor, e.g., a DSP processor. Alternatively or additionally, identifier 44 is implemented by a dedicated hardware circuitry unit or by a full scale processor. In some embodiments of the invention, security plug 40 receives power for its operation from an external power source, either directly or through modem 24. Alternatively or additionally, security plug 40 receives power from an internal battery. Further alternatively or additionally, security plug 40 receives power through the data line on which the signals are transmitted between modem 24 and RAS 28.

Optionally, security plug 40 comprises a clock 49 which is used in timing the transmission of the identification signals. In some embodiments of the invention, table 43 lists the identification signals to be transmitted on each connection together with the time, from the beginning of the connection, at which the signals should be transmitted. Optionally, when a signal which identifies the beginning of a connection is received by receiver 42, e.g., the CI signal defined in the V.8 recommendation, identifier 44 recognizes the signal and initializes a clock of the connection. Accordingly, the signals listed in table 43 are transmitted at their respective times. Alternatively, security plug 40 does not listen to the signals in the up-link channel but rather receives an external signal from modem 24, notifying that a new connection was initiated. Alternatively or additionally, security plug 40 listens to the signals on the down-link channel, i.e., from RAS 28 to modem 24.

Alternatively or additionally, table 43 identifies the transmission times of the identification signals by listing respective connection signals generated by modem 24 after which the identification signals are to be transmitted. When identifier 44 identifies on the connection one of the signals in table 43, the corresponding identification signal is transmitted thereafter by signal generator 46.

Alternatively or additionally, the timing of the transmission of the identification signals by security plug 40 depends on one or more signals on the down-link channel. For example, table 43 may list for each identification signal to be transmitted, a signal from the down-link channel which, upon its identification, an associated identification signal is transmitted.

In some embodiments of the invention, a plurality of identification signals are transmitted on each connection. For example, a first identification signal may be common to all the security plugs 40 used in connecting to RAS 28 and a second identification signal identifies the specific security plug 40 being used. Optionally, RAS keeper 34 manages a list of the identification signals for each of the security plugs 40 which are allowed access to server 26.

In some embodiments of the invention, the identification signals are transmitted at times and/or in frequencies which do not interfere with the up-link signals of the connection between modem 24 and RAS 28. Optionally, the identification signals are transmitted at predetermined points during the negotiation stage of the connection when it is known that no connection signals are transmitted or that the connection signals use only a portion of the frequency band of the lines of the connection. Alternatively or additionally, the identification signals are transmitted with low amplitudes such that the identification signals are ignored by RAS 28.

In an exemplary embodiment of the present invention, the identification signals are transmitted between the phases of the negotiation stage of the connection, for example, between phase 1 and phase 2 and/or between phase 2 and phase 3 of the modem negotiation procedure. In another exemplary embodiment of the invention, the identification signals are transmitted during the first phase of the negotiation stage of the connection, e.g., during a V.8 session, for example before or during the ANSam and/or CM signals. For example, an identification signal may be transmitted around about 3 kHz, while the CM signal is being transmitted around 2 kHz. Other frequencies may also be used for the identification signals, depending on the available frequencies (i.e., frequencies not used for communicating between modem 24 and RAS 28) at the specific time at which the identification signals are transmitted. It is noted that the available frequencies may be different at different times and/or for different protocols.

In some embodiments of the invention, security plug 40 comprises a delay circuit which delays the signals passing through the security plug for a short period. Security plug 40 examines the signals and if they do not use a predetermined band of frequencies for a predetermined amount of time, security plug 40 adds to the signals a predetermined identification signal. RAS keeper 34 examines the signals transmitted from modem 24 and if they do not use the predetermined frequency band for at least the predetermined time, RAS keeper 34 searches for the predetermined identification signal. If the predetermined identification signal is not found for over a predetermined number of times the connection is disconnected.

Alternatively or additionally, at times when specific known signals are to be transmitted, e.g., during the negotiation stage, security plug 40 replaces a portion of the known signals with an identification signal, in a manner which allows reconstruction of the signals by RAS keeper 34. For example, security plug 40 may replace one copy of a CM signal, which is transmitted in multiple copies, with an identification signal. RAS keeper 34 which receives the identification signal replaces the identification signal back to the original CM signal by duplicating a copy of the CM signal that was received earlier.

In some embodiments of the invention, the identification signals generated by signal generator 46 include simple cyclic signals of specific frequencies, amplitudes, phases and/or durations. Alternatively or additionally, the identification signals include modulated data such as an access code, a security plug code and/or any other code. Further alternatively or additionally, the identification signals are of any other type of signals.

In some embodiments of the invention, the identification signals are predetermined signals which are identical for each time a connection is established by modem 24. Alternatively, the identification signals change using any coding scheme known in the art. Optionally, the identification signals are selected and/or generated as a function of commands received from RAS keeper 34, the contents of the signals transmitted on the up-link and/or down-link channel and/or of external information, such as the time, date, and/or telephone numbers of modem 24 and/or of RAS 28.

In some embodiments of the invention, the contents of the transmitted identification signals and/or their timing are chosen responsive to the contents of signals transmitted on the up-link and/or down-link channel. Optionally, the contents of one or more of the identification signals depend on the signals transmitted from RAS 28 or modem 24, for example the contents of the CM or CJ signals of the V.8 protocol. Alternatively or additionally, the contents of one or more of the identification signals depend on the contents of the data signals, for example the identification signals may be a checksum or other function of the data signals. In some embodiments of the invention, different identification signals are transmitted and/or different timing schemes are used for different types of connections, e.g., V.34 versus V.90 connections. Alternatively or additionally, different identification signals are transmitted for different symbol rates and/or transmission rates.

Alternatively or additionally, RAS keeper 34 transmits identification request signals on the down-link channel to which security plug 40 must respond correctly. For example, RAS keeper 34 may transmit a seed code to which security plug 40 must apply a predetermined function in order to generate one or more of the identification signals. Alternatively or additionally, RAS keeper 34 transmits to security plug 40 indication of which of a plurality of identification codes it must transmit. In some embodiments of the invention, the signals transmitted by RAS keeper 34 are transmitted at predetermined times in which they do not interfere with the signals from RAS 28 to modem 24 passing on the down-link channel. Alternatively or additionally, any other of the above described methods for transmission of the identification signals on the up-link channel is used for the transmission on the down-link channel.

In some embodiments of the invention, RAS keeper 34 transmits to security plug 40 commands relating to the identification signals to be transmitted in future connections. For example, in each connection RAS keeper 34 may send a signal portion to be used in generating the identification signals of the next connection established using security plug 40. Alternatively or additionally, RAS keeper 34 sends, periodically, commands changing the identification signals used.

In some embodiments of the invention, RAS keeper 34 may operate in two modes, i.e., either with security checks as described above or without security checks. For example, at times in which a highly classified computer is not operative, RAS keeper 34 does not perform security checks. Optionally, in some embodiments including use of signal remover 36, the signal remover continues to cancel the signal effects due to security plug 40, even when RAS keeper 34 does not perform security checks. Alternatively or additionally, RAS keeper 34 may apply security checks to some connections while other security checks are not applied to other connections which are considered safe. For example, RAS keeper 34 may manage a list of telephone numbers from which connections do not require a security check.

The use of security checks at the physical level may be performed in addition to, or instead of, security checks at higher protocol levels. In some embodiments of the invention, security checks at the signal level are performed before a negotiation stage of a connection is completed between modem 24 and RAS 28, and before data signals are passed between client computer 22 and server 26. Thus, users which do not have a security plug 40 which produces proper identification signals, will not even have a chance to access server 26 or router 32. In some embodiments of the invention, security checks at the physical level are performed by dedicated hardware, such as RAS keeper 34, which may not be programmed remotely over a communication connection. Furthermore, in some embodiments of the invention, security checks at the physical level require generation of signals of a different nature than required for standard transmission of data and/or formation of connections. Therefore, a hacker must have special hardware in order to generate the identification signals.

Although in the above description RAS keeper 34 was described as being separate from RAS 28 and security plug 40 as being separate from modem 24, the principles of the present invention may be implemented in a RAS which also performs the tasks of RAS keeper 34 and/or by a modem which also performs the tasks of security plug 40.

It is noted that the access control methods of the present invention may be used in addition to or instead of other security methods, such as data coding and/or frequency scrambling.

The above described access control methods may be used for substantially any modem connections, such as connections of clients to an Internet service provider (ISP), connections of clients to a banking remote server, or connections of workers from their homes to a computer at their workplace.

Although the above described embodiments relate primarily to protection of computers from illegal modem connections, some of the features of the invention may be used also in protection of fax machines. In the protection of fax machines, the identification signals are optionally transmitted during an initial fax negotiation procedure and/or during the transmission of T.30 CNG and/or CED signals. Thus, the verification of the identity of the remote fax is established before any data and/or codes are exchanged on the fax connection. The protection of fax machines may be used, for example, to prevent attacks directed to determining the scrambling code of a fax machine and/or to prevent flooding faxes by remote messages. In addition, fax machine protection may be used to protect smart fax machines which transmit messages from the answering to the calling party.

It will be appreciated that the above described methods may be varied in many ways, including, changing the order of steps, and the exact implementation used. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments describe the best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of access control to a protected remote access server RAS, comprising:
receiving signals transmitted, between a modem and the RAS, on a modem connection, by a RAS keeper, in the RAS or along a link carrying the modem connection;
determining in the physical layer whether the received signals include predetermined identification signals; and
allowing the modem connection to be established with the protected remote access server only if the received signals include the predetermined identification signals.

2. A method according to claim 1, wherein determining whether the received signals include predetermined identification signals comprises determining by apparatus separate from the protected remote access server.

3. A method according to claim 1 or claim 2, wherein determining whether the received signals include predetermined identification signals comprises determining by apparatus which cannot be programmed remotely over the modem connection.

4. A method according to any of the preceding claims, wherein determining whether the received signals include predetermined identification signals comprises determining before data signals are transmitted on the modem connection.

5. A method according to any of the preceding claims, wherein determining whether the received signals include predetermined identification signals comprises determining before decoding data signals transmitted on the modem connection.

6. A method according to any of the preceding claims, wherein determining whether the received signals include predetermined identification signals comprises determining without decoding data signals transmitted on the modem connection.

7. A method according to any of the preceding claims, wherein determining whether the received signals include predetermined identification signals comprises determining after receiving specific signals of a negotiation stage of the modem connection.

8. A method according to any of the preceding claims, wherein determining whether the received signals include predetermined identification signals comprises determining at one or more predetermined times during the connection.

9. A method according to any of the preceding claims, wherein determining whether the received signals include predetermined identification signals comprises determining whether the frequency spectrum of the received signals have one or more predetermined characteristics.

10. A method according to any of the preceding claims, wherein determining whether the received signals include predetermined identification signals comprises determining whether the received signals include one or more predetermined modulated codes.

11. A method according to claim 10, wherein the modulated codes are modulated using a modulation method different from that used in modulating data signals passed on the connection.

12. A method according to any of the preceding claims, wherein determining whether the received signals include predetermined identification signals comprises determining whether the received signals include one or more predetermined frequency signals.

13. A method according to any of the preceding claims, comprising transmitting one or more signals on a down-link channel of the modem connection and wherein determining whether the received signals include predetermined identification signals comprises determining whether the received signals include signals generated responsive to the one or more down-link signals.

14. A method of providing identification signals for user authentication in a modem connection, comprising:
connecting a security plug between a modem and a remote access server;
transmitting signals between the modem and the remote access server; and
altering, during a connection establishment session, the transmitted signals, by the security plug.

15. A method according to claim 14, wherein altering the signals comprises passing the signals through at least one filter which alters the amplitude of a narrow frequency band of the signals.

16. A method according to claim 14 or claim 15, wherein connecting the security plug comprises connecting a passive element.

17. A method according to claim 14, wherein altering the signals comprises superimposing at least one identification signal on the signals transmitted from the modem.

18. A method according to claim 17, wherein superimposing the at least one identification signal to the signals transmitted from the modem comprises identifying a predetermined signal transmitted from the modem and superimposing a respective identification signal responsive to the identification.

19. A method according to claim 17, wherein superimposing the at least one identification signal to the signals transmitted from the modem comprises identifying a predetermined signal transmitted to the modem and superimposing a respective identification signal responsive to the identification.

20. A method according to claim 18 or claim 19, wherein superimposing the at least one identification signal comprises superimposing at a predetermined time after the identification of the predetermined signal.

21. A method according to any of claims 14-20, wherein connecting the security plug comprises connecting a security plug which does not change data signals transmitted between the modem and the remote access server in a manner which requires a change in their decoding.

22. A method according to claim 21, wherein connecting the security plug comprises connecting a security plug which does not change data signals transmitted between the modem and the remote access server.

23. A security plug, comprising:
an input interface which receives signals directed from a modem to a remote access server; and
an identification imprinting element which alters at least some of the signals received by the input interface so that the signals will pass a security check, but does not alter data signals in a manner which requires different decoding procedures than non-altered data signals.

24. A security plug according to claim 23, wherein the identification imprinting element comprises at least one narrow band filter.

25. A security plug according to claim 23 or claim 24, wherein the identification imprinting element alters signals only during a connection establishment period.

26. A security plug according to any of claims 23-25, wherein the identification imprinting element is powered from a line on which the signals from the modem to the remote access server are transmitted.

27. A security plug according to any of claims 23-25, wherein the identification imprinting element does not require a power source.

28. A security plug according to any of claims 23-25, comprising a battery which powers the identification imprinting element.

29. An access control unit, comprising:
an input interface adapted to receive signals directed from a modem to a remote access server;
a verification unit adapted to examine the signals received by the input interface in the physical layer to determine whether the received signals include predetermined identification signals; and
a gating unit which disconnects connections for which the received signals do not include the predetermined identification signals.

30. An access control unit according to claim 29, comprising an output interface which provides the received signals from the input interface substantially intact.

31. An access control unit according to claim 29, comprising a modification unit which removes at least some of the predetermined identification signals identified by the verification unit.
